(19) United States
(12) Patent Application Publication
(10) Pub. No.: US 2009/0177426 A1
(43) Pub. Date: Jul. 9, 2009

(54) Light Measurement Method and Apparatus

(76) Inventors: Gordon Ivan Dodds, Banbridge (GB); Karen McMenemy, Dungannon (GB); Ashraf Zatari, Belfast (GB)

Correspondence Address: CHOATE, HALL & STEWART LLP, TWO INTERNATIONAL PLACE, BOSTON, MA, 02110, US

(21) Appl. No.: 11/996,556

(22) PCT Filed: Jul. 24, 2006
(86) PCT No.: PCT/GB2006/002774

§ 371 Date: Feb. 24, 2009

(30) Foreign Application Priority Data
Jul. 23, 2005 (GB) 0515157.6

(51) Int. Cl. G01J 1/08; G06F 19/00

(52) U.S. Cl. 702/85; 356/213

(57) ABSTRACT

A light measurement method is provided comprising: determining one or more correction factors for at least one image capture device, using the image capture device to receive light output from at least one source of illumination, obtaining an output from the image capture device which corresponds to the light output of the source of illumination, and applying the or each correction factor to the output of the image capture device to obtain one or more substantially absolute measure of the light output of the source of illumination. A light measurement apparatus is also provided to carry out the light measurement method.

The present invention relates to a light measurement method and particularly, but not exclusively, to a method of preventing saturation and distortion errors whilst taking luminance, illuminance and luminous intensity measurements using an array of image detecting sensors. Apparatus adapted to take light measurements is also described.

It is necessary to ensure that illumination of areas such as roads and airport runways and approaches is sufficient such that they comply with relevant safety standards. Whilst it is relatively straightforward to assess the illumination provided by luminaires etc. in an indoor environment during manufacturing, it is far more difficult to ensure that the actual illumination provided to the area is sufficient when the luminaires have been installed due to various factors which are not readily simulated in an indoor testing environment. The illumination provided across the area must also be assessed at regular intervals to ensure that safe standards are maintained during the passage of time (i.e. the quality and/or luminous intensity of the light produced by individual bulbs within a luminaire may deteriorate with time).

The difficulty arises due to various unknowns that are not present in a laboratory environment such as the surface material and relief of the illuminated area, the positioning and alignment of the lighting once installed, the large overall areas involved etc.

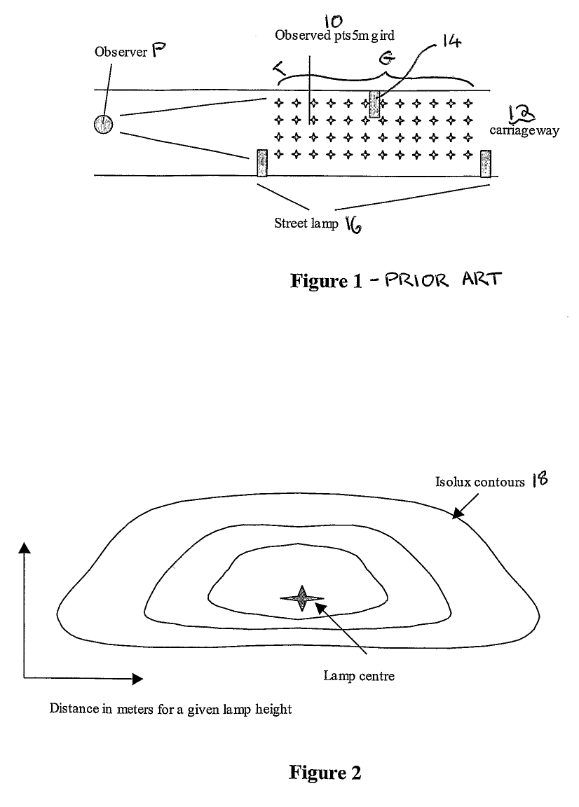

Typical methods of attempting to take such actual outdoor measurements involve laying out a grid pattern (such as that shown in FIG. 1) on the illuminated area and calculating the illumination provided over each area of the grid using a fixed observation point; however, complying with safety standards such as BS 5489 and CEN 13201 whilst doing this is complicated by the requirement that street lighting luminance must be measured in 5 meter intervals along the roadway. BS 5489 and CEN 13201 set out detailed requirements covering luminance and glare. Referring to FIG. 1, these requirements are typically complied with by arranging a grid formation G across and along the roadway a suitable distance away from an observation point P which is generally at least 60 meters away from the grid G. Grid points 10, spaced apart at 0.5 m intervals, are marked onto the roadway 12 at an area under a central street luminaire 14 between opposing street luminaires 16 on the opposite side of roadway 12. A measurement of the luminance (candela per metre squared) is taken manually using a luminance meter (not shown) from the observation point P for each grid point 10. A measurement of illuminance (lux) using an illuminance meter can also be taken at each grid point. A graph, such as that shown in FIG. 2, can then be drawn up showing the isolux contours 18 and therefore the illuminance on the roadway beneath the street luminaire.

Obviously, there are disadvantages associated with measuring luminance and creating isolux contour diagrams in this manner. Firstly, the roadway has to be closed whilst measurement takes place. Secondly, the measurements are manpower and time intensive as a grid has to be firstly marked out and then measurements taken for each grid point. There are also various opportunities for errors to be introduced into the measurements.

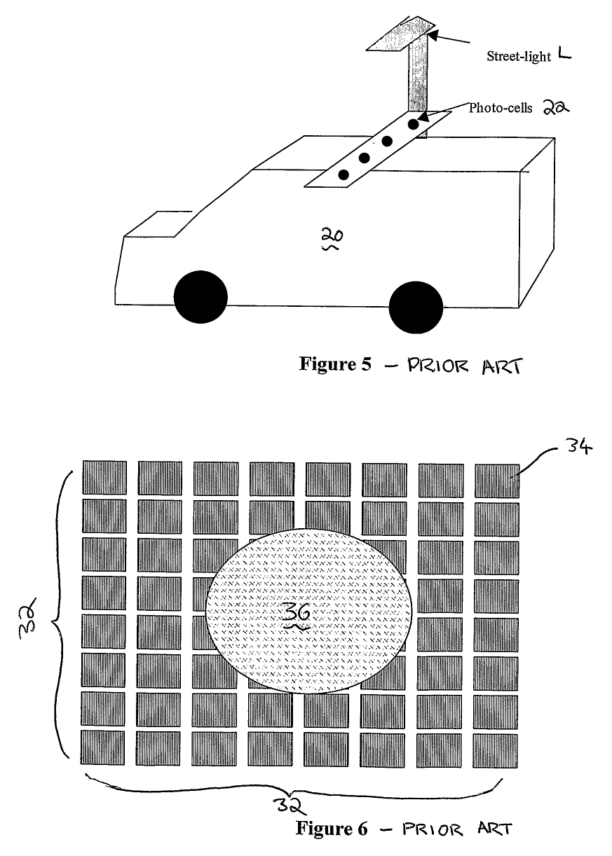

A less disruptive way of obtaining the required data is to mount sensors on a moving vehicle or trailer (such as those shown in FIGS. 4 and 5) and perform the measurements whilst that vehicle or trailer moves through the illuminated area. Typically, these sensors measure the illumination using single cell photo-devices which are combined with optics for allowing both directional and ambient light measurements.

Referring to FIG. 5, a vehicle 20 with an array of photocells 22 mounted on the vehicle's roof is provided. Luminance values are estimated using the row of photocells 22 and relating the values detected to the vehicle's position with respect to the street luminaire L. In this method, the location of the luminaire L is estimated by assuming that the point of maximum light received at the photocells 22 corresponds with the centre of the luminaire L. This method has difficulty in accurately finding the position of each luminaire L with respect to the value measured and, furthermore, there is a possibility that the head of the street luminaire L is misaligned with respect to the array of photocells 22.

Lighting for airport runways and approaches must also meet certain guidelines (such as those defined by the Civil Aviation Authority (CAA) and the International Civil Aviation Organization (ICAO)) to ensure that the runway and approach layout is sufficiently visible to incoming aircraft.

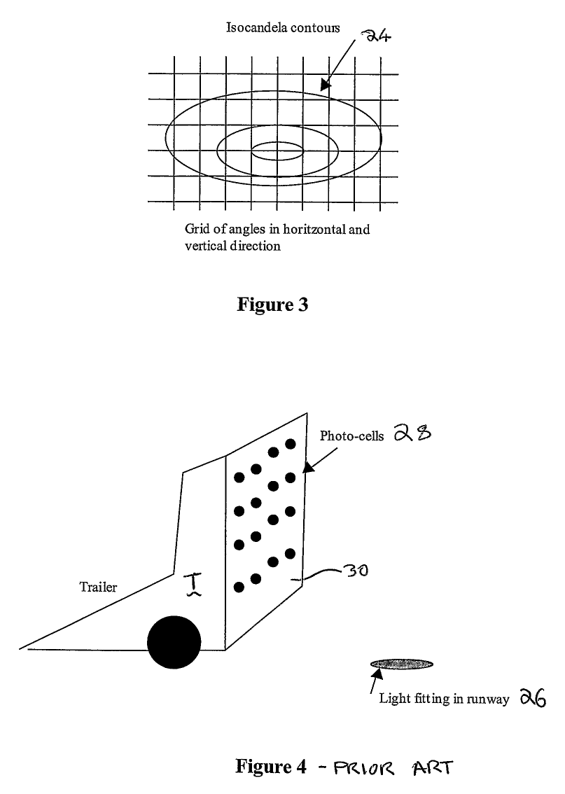

The luminous intensity of airport runway and approach luminaires are measured in candelas (cd) in a particular direction. FIG. 3 shows ideal isocandela contours 24 as desired for an individual runway and approach luminaire.

In practice, it is extremely difficult to measure the required luminous intensity from a runway and approach luminaire since the desired direction of measurement would be the normal approach angle of an aircraft for each individual luminaire. This can be solved by hovering a helicopter provided with a luminous intensity meter in the desired position and taking the appropriate measurements for each individual runway and approach luminaire. Obviously, this method is time consuming and requires that the runway and approach be out of use while the measurements are taken.

Another solution for measuring luminous intensity of only airport runway lighting utilises a vehicle trailer mounted with a grid of photo-cells as shown in FIG. 4. The trailer T is towed along the runway and over the runway luminaires of interest 26. The distance along the runway from a reference point is estimated with odometers. The lighting output for each light 26 is estimated as the trailer T moves over it. Clearly, the observation angles will vary with distance. To account for this several columns of cells 28 cover the expected luminaire angles as shown in FIG. 4.

The photocells 28 in this case are all arranged on a vertical face 30 of the trailer T. The distance to the luminaire 26 must be accurately known, so that the constant area of the photocell 28 can be related to the luminous intensity of the luminaire 26 observed by each photocell 28 in a particular direction. The angle of the luminaire 26 with respect to each cell 28 is also important, since the luminous intensity will reduce as the observation angle deviates from zero degrees (where the cell 28 points directly at the luminaire 26). This method is restricted to ground lighting and the reading for a particular luminaire 26 may be affected by adjacent luminaires. In addition, the distance measurement from the reference point taken by the odometer can cause inaccuracies in the measurements obtained. This method of assessment cannot measure the luminous intensity of airport approach luminaires, as these are elevated above the ground and extend beyond the runway.

One or more of the downsides of the apparatus and methods described above could be overcome by using a camera comprising an array of light sensitive pixels, such as a Charge Coupled Device (CCD) camera. However, such cameras present a number of other problems including:—
1) The image gathered by the CCD camera can often be illegible due to saturation of the image caused by high levels of brightness;
2) The lens of the camera typically distorts the image in such a way that the actual position of the luminaire may be different from the apparent position of the luminaire through the lens;
3) The CCD camera is typically unable to interpret the relationship between the brightness measured by a pixel and the actual brightness of the particular type of luminaire viewed; and
4) Typical CCD cameras are unable to track the movement of a particular light across the image with time; this is necessary to obtain a correct overall measurement for each individual luminaire.

According to a first aspect of the present invention, there is provided a light measurement method comprising:
determining one or more correction factors for at least one image capture device,
using the image capture device to receive light output from at least one source of illumination,
obtaining an output from the image capture device which corresponds to the light output of the source of illumination, and
applying the or each correction factor to the output of the image capture device to obtain one or more substantially absolute measure of the light output of the source of illumination.

The image capture device may be moving with respect to the source of illumination, whilst being used to receive light output from the source of illumination.

The image capture device may be a camera. The camera may be a charge coupled device (CCD) camera. Obtaining an output from the CCD camera which corresponds to the light output of the source of illumination may comprise obtaining one or more grey level output signals from one or more CCD pixels of the CCD camera. The camera may be a complementary metal oxide semiconductor (CMOS) camera.

The source of illumination may comprise a road surface, and the method may comprise obtaining at least one substantially absolute measure of the luminance of the road surface and/or at least one substantially absolute measure of the illuminance from the road surface. The luminance of the road surface may result from reflection of light output from one or more street luminaires from the road surface.

The source of illumination may comprises one or more luminaires on or near an airport runway and approach, and the method may comprise obtaining at least one substantially absolute measure of the luminous intensity of at least some of the luminaires.

An absolute measure of the light output of the source of illumination is required, in order to ascertain if, for example, sources associated with roads or runways are giving sufficient light output. However, the relationship between the measured output of the image capture device and the actual output of the source may not be known.

The method may comprise applying an image capture device measurement correction factor determined by using the image capture device to receive light output from a source of illumination, using a luminance meter to measure the absolute light output of the source of illumination, and determining the image capture device measurement correction factor by comparing the output of the image capture device with the output of the luminance meter.

Determining the image capture device measurement correction factor may comprise simultaneously using the image capture device and the luminance meter to receive light output from the source of illumination, recording the output from the luminance meter, calculating the apparent area presented to the luminance meter by the source of illumination, multiplying the output of the luminance meter by the calculated area in order to arrive at a substantially absolute value of the light output of the source of illumination, and determining the image capture device measurement correction factor to have a value such that when the correction factor is multiplied by the output of the image capture device, the substantially absolute value of the light output of the source of illumination as measured by the luminance meter is obtained.

The method may comprise applying a source of illumination output level correction factor determined by using an image capture device to receive light output from a source of illumination at different output levels of the source, deriving a relationship between an output of the image capture device and the light output level of the source, and using the relationship to determine the source of illumination output level correction factor.

The method may comprise applying a distance correction factor determined by using an image capture device to receive light output from a source of illumination positioned at a particular distance from the image capture device, using the inverse square law to derive a relationship between an output of the image capture device and the distance, and using the relationship to determine the distance correction factor.

The method may comprise applying an image capture device vibration correction factor determined by using an image capture device to receive light output from a source of illumination, in a first measurement situation where the image capture device is stationary and in a second measurement situation where the image capture device is subject to vibration, and using outputs of the image capture device for the first and second measurement situations to calculate the image capture device vibration correction factor.

The method may comprise applying a lens distortion correction factor determined by using an image capture device comprising at least one lens to view a grid of squares with known distribution, and using a measured image of the grid of squares to calculate the lens distortion correction factor. The calculation may comprise using a sixth order polynomial algorithm. This may be applied for any distance between the image capture device and the source of illumination.

The method may comprise applying an image detecting means non-uniformity correction factor determined by using an image capture device comprising a plurality of image detecting means to receive light output from a source of illumination which produces a uniform luminance, determining that an output signal produced by one or more central image detecting means is a true measure of the luminance of the source of illumination, and calculating an image detecting means non-uniformity correction factor for each other image detecting means, which will convert a measured output signal of the other image detecting means to the output of the one or more central image detecting means.

The method may comprise applying an image detecting means saturation correction factor determined by using an image capture device comprising a plurality of image detecting means to receive light output from a source of illumination, determining a maximum threshold output for the image detecting means, and using one or more settings of the image capture device to calculate the image detecting means saturation correction factor which when applied to the image capture device will ensure the output of the image detecting means are maintained below the maximum threshold output.

The method may comprise applying a light dissipation correction factor determined by using an image capture device to receive light from a source of illumination, the output of which is known, at a range of distances between the image capture means and the source of illumination, and using measured outputs of the image capture device at the distances to calculate the light dissipation correction factor.

When light measurements are made for luminaires of airport runways and approaches, the image capture device is placed on board an aircraft. The light measurements of the luminaires are therefore made through the window of the aircraft. This will have an effect on the measurement of the absolute light output of the luminaires. The method may comprise applying a window correction factor determined by using an image capture device to receive light output from a control luminaire, the output of which is known, with the window of the aircraft between the device and the control luminaire, and with no window of the aircraft between the device and the control luminaire, estimating a decrease in the light output of the control luminaire due to the aircraft window, and using this to determine the window correction factor.

The method may further comprise selectively obtaining light measurements from a plurality of sources of illumination simultaneously using a single image capture device. This may be achieved by performing the following steps:—
identifying each source of illumination in an image received by the image capture device by assigning each source of illumination with a number derived from a counter loop; and
using image flow techniques in order to track each identified source of illumination through the movement of each identified source of illumination through the image.

The counter loop may be adapted to take account of any inconsistencies in a lighting pattern provided by the plurality of sources of illumination in the image, such as luminaire outages or obscured luminaires.

The method may further comprise adjusting magnification provided by one or more lenses of the image capture device, in order to allow at least one image detecting means per source of illumination being viewed by the image capture device. This may be achieved by viewing the or each source of illumination through a first lens when said image capture device is at a distance below a threshold distance from the or each source of illumination, and viewing the or each source of illumination through a second lens when said image capture device is above the threshold distance from the or each source of illumination, the first and second lenses providing different magnifications. Optionally, the first and second lenses are provided by first and second image capture devices.

Alternatively, the first and second lenses are interchangeable lenses provided by a single image capture device.

The method may comprise obtaining a uniformity assessment of the light output from a plurality of sources of illumination. In an airport lighting situation, it is possible to obtain a uniformity assessment of the plurality of light sources. This would not involve the complexities of computing the luminous intensity of each light sources within the runway installation. Obtaining a uniformity assessment of the light output of the plurality of sources of illumination may comprise using the knowledge that an output of the image capture device corresponding to a source of illumination is a measure of the luminous intensity of the source of illumination, and all sources of illumination which should be emitting a similar luminous intensity, when the image capture device is a given distance from them, can be grouped into bands of sources of illumination. In each band, a source of illumination can be uniquely identified and its light output extracted using algorithms similar to those previously described. All sources of illumination within a given band should have similar light output performance and as such can be compared to other sources of illumination within the same band. When comparing sources of illumination in a given band, certain factors need to be considered, such as, some of the sources of illumination may be over performing, some may be under performing, some may be obscured or some may be not be producing any light output. Whilst this method will not compute the luminous intensity of each source of illumination, it will give a much quicker assessment of the uniformity of the plurality of sources of illumination in each band. It is also a quick means to identify missing or comparatively under performing sources of illumination.

According to a second aspect of the present invention there is provided a light measurement apparatus comprising at least one image capture device and processing means which stores one or more correction factors, receives an output of the image capture device corresponding to a light output of a source of illumination, and applies the or each correction factor to the output of the image capture device to obtain one or more substantially absolute measure of the light output of the source of illumination.

The image capture device may comprise a CCD camera. The image capture device may comprise a CMOS camera.

According to a third aspect of the present invention there is provided a calibration apparatus to calibrate an image capture device in order to obtain light measurement data, the apparatus comprising:—
an image capture device adapted to capture an image of a source of illumination;
image detecting means adapted to detect an image of said source of illumination and produce an output representative of said image;
focusing means adapted to focus the image captured by said image capture device upon said image detecting means;
a luminance meter adapted to detect the luminous intensity of said source of illumination;
wherein said image detecting means is adapted to produce an output substantially corresponding to the luminous intensity detected by said luminance meter.

The apparatus may also be selectively provided with a calibration grid adapted to correct distortion of said image caused by said focusing means.

Optionally, said focusing means comprises a lens capable of sufficiently focusing said image detecting means for all distances. Alternatively, said focusing means comprises a first lens adapted to focus said image on said image detecting means at relatively short distances and a second lens adapted to focus said image on said image detecting means at relatively long distances.

Embodiments of the present invention will now be described, by way of example only, with reference to the accompanying drawings, in which:

FIG. 1 is a schematic planar view of a prior art grid arrangement for measuring street lighting not in accordance with the present invention;

FIG. 2 is an isolux graph illustrating contours produced for illuminance measurement of street lighting;

FIG. 3 is an isocandela graph illustrating contours produced for luminous intensity measurement of runway and approach lighting;

FIG. 4 is a schematic diagram showing a prior art trailer provided with photo sensors for assessing illumination of an aircraft runway and approach;

FIG. 5 is a schematic diagram showing a prior art vehicle provided with an array of photo cells for measuring the light output of street luminaires;

FIG. 6 is a planar schematic diagram showing the footprint of viewed luminaire on an array of CCD pixels of a CCD camera used in the method of the invention;

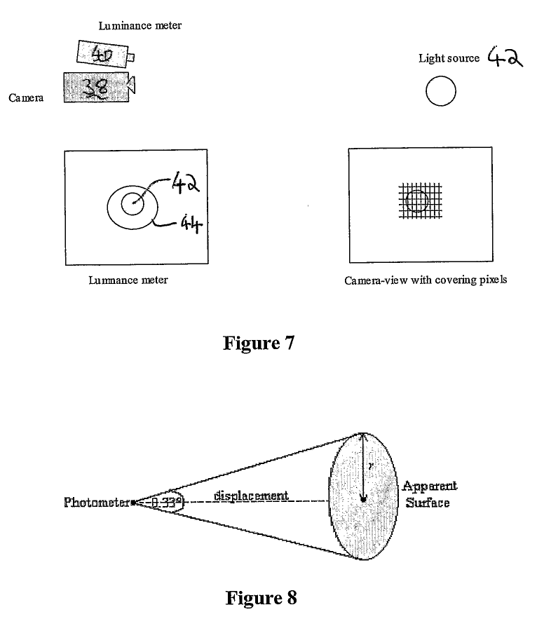

FIG. 7 is a schematic block diagram illustrating the calibration of a CCD camera used in the light measurement method of the present invention;

FIG. 8 is a geometric diagram showing the calculation of area viewed by a luminance meter in the calibration shown in FIG. 7; and

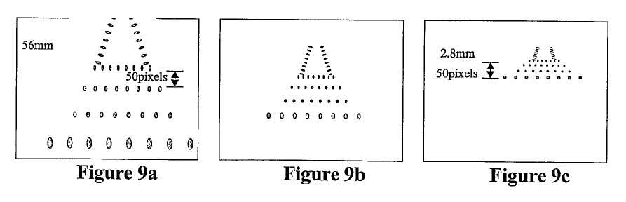

FIGS. 9a to 9c are illustrations of the resolution provided by lenses of a CCD camera with varying focal length, used in the method of the invention.

The following description discusses a number of light properties which are defined as follows.

The luminous intensity of a source is measured in candelas (cd) (this can be stated in terms of SI units where 1 candela is equal to a source that emits monochromatic radiation, in a given direction, at a frequency of 540×10¹² hertz with an intensity in that direction of 1/683 watt per steradian). The luminous intensity is the luminous flux emitted per unit solid angle by a point source in a given direction.

The total luminous flux of a source is measured in lumens (also termed candela-steradian (cd sr)). The luminous flux is essentially the integral of the luminous intensity over all solid angles.

The illuminance of a surface is the luminous flux reaching it perpendicularly per unit area, and is measured in lux (lx), where 1 lux=1 lumen/square metre.

Luminance of a surface is the amount of light being emitted by the surface (e.g. a road surface), and is defined as the luminous intensity of the surface in a specific direction, divided by the projected area of the surface as viewed from that direction. Unless the surface is perfectly diffusing, the luminance will vary, depending on the reflective characteristics of the material of the surface. The unit of luminance is candelas per metre squared (cd/m²). When stating the luminance for a surface, its orientation will always have to be given. For instance, the luminance of a desk is measured as the horizontal luminance and the luminance of a facade as vertical luminance etc.

Glare is caused by conflicting sources of light that hide the desired scene from the observer. Glare is also an important factor when considering the light output of a range of luminaires. In the context of the present application, glare is often only measured after an accident or if a bad design of the road layout is identified.

The light measurement method of the first aspect of the invention, comprises determining one or more correction factors for at least one image capture device, using the image capture device to receive light output from at least one source of illumination, obtaining an output from the image capture device which corresponds to the light output of the source of illumination, and applying the or each correction factor to the output of the image capture device to obtain one or more substantially absolute measure of the light output of the source of illumination.

The method is carried out using the apparatus of the second aspect of the invention, which comprises at least one image capture device and processing means which stores the or each correction factor, receives the output of the image capture device and applies the or each correction factor to the output to obtain the or each substantially absolute measure of the output of the source of illumination.

An embodiment of the invention will now be described, in which an image capture device is used to receive light output from a source of illumination. It will be appreciated, however, that the invention encompasses light measurement methods and apparatus in which one or more image capture devices are used to receive light output from one or more sources of illumination.

The image capture device is moving with respect to the source of illumination, whilst being used to receive light output from the source of illumination. This allows, for example, light output to be received from sources of light associated with roads or airport runways and approaches in an acceptable period of time, without having to close the road or runway and approach as is the case when the light output of such sources are measured using stationary image capture devices, such as luminance meters.

The image capture device comprises a charge coupled device (CCD) camera. It will be appreciated, however, that other types of cameras, such as CMOS cameras, may be used. The CCD camera comprises at least one lens, which directs light from the source of illumination onto image detecting means of the CCD camera. The light from the source is focused, but also distorted, by the lens. The image detecting means comprises an array 32 of individual image detecting elements comprising CCD picture elements or pixels 34, as shown in FIG. 6. Light from the source of illumination is focused by the lens to impinge on the pixels 34, in the form of a light footprint 36, which is a representation of an image of the source of illumination. As can be seen from FIG. 6, the footprint 36 generally completely covers some of the pixels 34 and partially covers other of the pixels 34. For each of these pixels, a grey level output signal is produced, which is proportional to the light intensity of the footprint impinging on a pixel and the fraction of the area of the pixel covered by the light footprint. The intensity of light across the footprint 36 may not be uniform, depending on what the source of illumination comprises, e.g. a road surface or a luminaire e.g. comprising an excitation element, LED, tungsten filament, etc. and reflecting surfaces, glass/plastic lenses, cowlings, reflectors, etc.

If the light footprint from the source of illumination is small enough that its total area covers less than one pixel 34 of the CCD camera viewing the source, the grey level output signal from that pixel will vary according to the inverse square law with distance from the source. However, any pixels 34 of the CCD camera which are fully covered by the light footprint, will not change their grey level output signal with changing distance between the CCD camera and the source, i.e. in contrast with the normally expected inverse square law. Each fully covered pixel 34 effectively observes an infinitely wide luminance surface of the source of illumination, and in this case, the light intensity of the footprint entering the pixel 34 is constant with varying distance from the source, producing a constant grey level output signal of the pixel.

The correction factors for the CCD camera are determined as follows. This is carried out prior to taking light measurements in situ, e.g. of a road surface or a runway and approach. Determination of the correction factors is carried out using a source of illumination which is the same as that which will be encountered in situ, e.g. for airport runways and approaches, a runway and approach luminaire.

The correction factors are determined using a number of sources of illumination (typically around five) of the same type as those to be assessed by the CCD camera in situ. For normal sources of illumination, measurement with one source would be sufficient to cover a wide selection of sources; however, an increasing number of special sources which use, e.g. LEDs as a source and a modulation over time to produce a particular spectrum, are being used. Such special sources require the correction factor determination process to take place over an extended time period. This is achieved by carrying out the process for a period of 20 minutes prior to testing.

The CCD pixels 34 of the camera will have different light sensitivities, caused by, for example, minor imperfections produced during the manufacturing process of the pixels. The variation in light sensitivity is greatest for the pixels 34 furthest from the centre of the array 32. The differing light sensitivities of the pixels is calibrated for, using an integrating sphere which produces a uniform luminance across its surface. Measurements are made of the luminance of the integrating sphere, and the grey level output signal produced by each pixel 34 of the CCD camera is recorded. Calculation of correction factors is then carried out, by determining that the grey level output signal produced by a pixel 34 in the centre of the array 32, is a true measure of the luminance of the integrating sphere, and calculating a pixel non-uniformity correction factor for each other pixel 34, which will convert the measured grey level output signal of the pixel to the grey level output signal of the centre pixel. The calculated pixel non-uniformity correction factors are stored, for subsequent application to the grey level output signals of each pixel when light measurements are made in situ. In an alternative correction factor calculation, the average grey level output signal (gₐᵥₑ) of a number of pixels in a small central area of the array 32 is determined, the average grey level output signal (gₒₜₕₑᵣ) of all the other pixels in the array 32 is determined, and a single pixel non-uniformity correction factor is calculated by dividing (gₐᵥₑ) by (gₒₜₕₑᵣ). This pixel non-uniformity correction factor is stored, for subsequent application to the grey level output signal of each pixel 34 when light measurements are made in situ. The small central area of pixels is chosen such that the area is small enough to be subjected to minimal distortion and lens effects of the CCD camera, but large enough to compensate for an average inter-pixel noise.

The lens (or lenses) of the CCD camera will cause more light to fall on the centre pixels 34 than on the edge pixels 34 of the array 32. This also requires correction. This is achieved in the above described correction for variations in the pixel light sensitivities, i.e. in the above correction, the grey level signal outputs of the edge pixels are scaled using a pixel non-uniformity correction factor in order to have the same grey level output signal as the centre pixel or number of centre pixels. This is known as vignetting.

The lens or lenses of the CCD camera will also cause distortion in the image of the source of illumination. In order to ensure accurate measurements of the actual position of the source of illumination, it is necessary to correct the inherent distortion caused by the lens or lenses. This is done by measuring the distortion using a fixed grid of squares that is placed perpendicularly in front of the camera at a known distance therefrom. The location at which the lines of the grid cross are identified by the array 32 of pixels 34 (since the detected image at these locations will be relatively dark). A sixth order polynomial algorithm is then used to convert the radial distance of the activated pixels 34 from the centre of the array 32, to the radial distance of the viewed squares from the centre of the grid. This relationship can then be used to calculate a lens distortion correction factor, which is stored for subsequent application to the apparent position of a source of illumination to obtain its actual real world position, when taking light measurements in situ. Thus the distortion error caused by the lens of the camera is eliminated. This method also gives the centre of distortion of the pixel array matrix, which is necessary when deriving the camera calibration matrix so that the position and orientation of the camera from the source of illumination can be calculated.

The CCD camera will typically comprise at least one colour filter. The or each colour filter will restrict the wavelength of light impinging upon each pixel 34 of the CCD camera, and this affects the grey level output signal produced by the pixels 34. In order to obtain accurate light measurements in situ, a filter correction factor is calculated, and stored for subsequent application to light measurements in situ. Alternatively, a monochrome camera may be utilised for light measurements, if the luminaire colour classification is not important.

Due to the mode of operation of the CCD pixels of the CCD camera used in the method, the pixels will have an upper limit of the light output of a source of illumination which they can detect. Above this detection limit, the pixels will saturate, and as the light output increases further, the grey level output signals of the pixels remain the same. Reaching the detection limit of the pixels is obviously undesirable, as a true measure of the light output of the source may not then be obtained, and also operating the pixels at or above this limit is not recommended. Reaching the detection limit of the pixels may be avoided by controlling various settings of the CCD camera, for example the focal number and the shutter speed, and employing devices such as a neutral density filter (a camera filter that reduces the light intensity uniformly across the visible spectrum). The CCD camera is set up to a view a source of illumination, which is a source, e.g. a luminaire, which will be measured in situ, with the footprint of this is focused on the central pixels 34 in the array 32 by the lens of the camera. The grey level output signals of these pixels are monitored, and the settings of the CCD camera and the neutral density filter are adjusted to determine when saturation of the pixels occurs. The values of the settings at saturation are recorded, and when light measurements are made in situ, setting correction factors are employed to ensure that saturation of the pixels does not occur, i.e. the detection limit of the pixels is not reached. Determination of this correction need only be carried out for a footprint of the source of illumination focused on the centre of the array 32 of pixels 34, since, due to the focusing effect of the lens of the CCD camera, if saturation of the central pixels is avoided then the surrounding pixels will not be saturated. It should be noted that, in choosing settings of the CCD camera, it is not advisable for the shutter speed to be faster than 1/50s, since this may cause a pulsating phenomenon with certain types of source of illumination, such as arc or incandescent light sources.

The CCD camera to be used in the light measurement method in situ, is calibrated for a range of different output levels of the source of illumination. Camera settings, e.g. iris shutter speeds and neutral density filter settings, are chosen such that saturation of the pixels does not occur, and the camera is set up to obtain light measurements from a source of illumination at different light output levels of the source. A linear relationship is derived between the grey level output of a pixel 34 fully covered by the footprint of the source and the light output level of the source. It should be noted that this linear relationship generally only applies in the grey level output signal region between 0 and 250. At the extreme limits at, or approaching, 0, and above 250, a significant level of noise can result in non-linear relationships. (This assumes that an 8 bit CCD camera is used where the maximum pixel grey level is 255. Alternatively, a higher bit camera can be used which leads to an extended grey level range.) The linear relationship determines a source of illumination output level correction factor, which is recorded, allowing appropriate selection of the camera settings for the light intensity levels encountered in situ.

In some in situ circumstances, the CCD camera used to obtain the light measurements may be subject to vibration. This would be the case, for example, when the camera is mounted in an aircraft for light measurements of runway and approach luminaires. The CCD camera is calibrated to take into the account such vibrations. The CCD camera is set up to view a source of illumination, and the vibration that the camera is likely to be exposed to in situ, is simulated and applied to the camera, whilst it is recording light measurements from the source. The same CCD camera and source are then used to record light measurements, for no vibration of the camera. The results for the two measurement situations are compared, and a vibration correction factor calculated which accounts for the vibrations. This is stored, for subsequent application to the light measurements made in situ.

An absolute measure of the light output of the source of illumination is required, in order to ascertain if, for example, sources associated with roads or runways and approaches are giving sufficient light output. However, the relationship between the measured grey level output signals of the pixels of the CCD camera and the actual output of a source is not known. This must be determined, before the camera can be used in situ. This is done using the arrangement shown in FIG. 7. A source of illumination 42 is viewed by a CCD camera 38, and also by a calibrated luminance meter 40. The entire area of the source 42 should be enclosed within the acceptance angle of the luminance meter 40 (and the camera 38), and this is achieved using the luminance meter 40 viewer, and ensuring that the area of the source 42 is within the limit boundary 44 of the viewer. The luminance meter 40 provides a luminance value (in cd/m²) of the source 42. The total light output of the source 42 can be calculated from this, e.g. if the luminance value reads 50,000 cd/m², then the total light output from the source 42 will be 50,000 cd multiplied by the area which the acceptance angle of the luminance meter 40 covers at the distance from the luminance meter 40 to the source 42. Referring to FIG. 8, and using the example of the luminance meter 40 having a 0.3 degree acceptance angle, and a distance of 10 m between the meter 40 and the source 42, the area that the meter 40 views can be calculated according to the equation (1) below:—

$$Area = π {r}^{2} = {π ( 10 tan \frac{03}{2} )}^{2} = 0.028798 {m}^{2} \qquad Eqn ( 1 )$$

In this example, the total light output from the source 42 measured by the luminance meter 40, is therefore calculated as:—

50000×0.028798=1440cd Eqn (2)

Thus the light output from the source 42, expected to be detected by the CCD camera 38 is 1440 cd in this direction. This light output value is used to calculate a camera measurement correction factor for each of the pixels of the camera, which will convert the measured grey level output signal of the pixel to the grey level output signal necessary so that the output signal of the camera 38 is concurrent with the light output value measured by the meter 40. Alternatively, the camera measurement correction factor may be used to convert the sum of the measured grey level output signals of the pixels to the grey level output signal necessary so that the output signal of the camera 38 is concurrent with the light output value measured by the meter 40.

Once the correction factors for the CCD camera have been determined as above, the camera can be placed in situ. Once in place, further correction factors may be determined.

If the light footprint of the source of illumination being viewed by the CCD camera is of a size which covers only a small number of pixels of the camera, the edge pixels will have a significant effect on the light measurements obtained. To account for this, it may be desirable to reduce the allowable noise threshold of the pixels, in order to maintain the accuracy of the light measurements obtained. Alternatively, if the light footprint of the source if illumination covers less than a predetermined minimum number of CCD pixels, the source will not be accepted for measurement.

Due to the structure of the array 32 of CCD pixels 34 of the CCD camera, a number of gaps are present between the pixels 34 of the array 32. Clearly, since a portion of the light of the footprint of the source of illumination impinges on these gaps, a certain amount of light output of the source will be unmeasured by the pixels 34. As the size of the light footprint becomes smaller, the effect of the gaps on the light measurement obtained will depend upon the location of the footprint on the array of pixels. For example, if a small light footprint impinges upon the juncture between four pixel corners, a large amount of light output will be unmeasured. If a small light footprint, less than 1 pixel in area, impinges upon the centre of a pixel, no light output will be unmeasured. Therefore, if the light footprint of the source of illumination being measured in situ, only impinges on a small number of pixels, the allowable noise threshold of the pixels may be reduced, to ensure that the light footprint is detected. As light measurements are made by a moving camera, the light footprint of the source of illumination is continuously moving across the array of pixels of the camera, and the effect of loss of light measurement due to the gaps can be diminished, by averaging multiple frames of the footprint. Alternatively, a minimum CCD pixel coverage can be set, so that only sources of illumination which have a pixel coverage greater than this minimum will be accepted for measurement. In the case of a dynamic measurement system, this loss of data is not critical because as the measurement system approaches the source in question, its pixel coverage will increase beyond this minimum and it will be accepted for measurement.

When light measurements are made in situ, the distance between the CCD camera and the source of illumination coupled with the weather conditions in which the measurements are taken, introduces the opportunity for light dissipation (and possibly distortion) to occur before the light from the source even reaches the camera. This will obviously affect the measurement of in situ absolute light output of the source of illumination. This may be compensated for by taking light measurements in situ from a single control luminaire, the output of which is known, at a suitable range of distances from the control luminaire. Any dissipation in the light output of the control luminaire due to, for example, weather conditions, can therefore be estimated. The measurements of the output of the control luminaire are used to calculate a light dissipation correction factor, which can be used to correct the light output measurements obtained in situ from the source of illumination.

When light measurements are made for luminaires of airport runways and approaches, the CCD camera is placed on board an aircraft. The light measurements are therefore made through the window of the aircraft. This will have an effect on the measurement of the absolute light output of the luminaires. This may be compensated for by using a CCD camera to take light measurements from a control luminaire, the output of which is known, with the window of the aircraft between the camera and the control luminaire, and with no window of the aircraft between the camera and the control luminaire. The decrease in the light output of the control luminaire due to the aircraft window is estimated, and used to determine a window correction factor for the light measurements obtained from the runway and approach luminaires.

Once all of the correction factors have been determined, the CCD camera is set up in situ to view a source of illumination. The CCD camera receives light output from the source, which is focused on the pixel array of the camera to produce an output of the camera in the form of pixel grey level signals, which corresponds to the light output of the source. The grey level output signal for each pixel which is over a pre-determined threshold signal (determined by, for example, noise considerations), is recorded. The distance of the CCD camera from the source of illumination is also estimated and recorded. The estimate of the distance is obtained in a number of ways. For example, in an airport environment a CAD reference map of the luminaire positions is available, where the position of each source is tied directly to a GPS co-ordinate frame. With the CAD information and the spatially calibrated path of the images in the CCD camera (obtained through standard imaging techniques) the position of the CCD camera in 3D space can be estimated. In a road lighting environment, GPS allows the CCD camera to locate its position accurately on the ground in 2D. Since a vehicle is practically limited to 2D motion, that is, it moves up and down very little with respect to the road surface and will have very little tendency to roll, pitch and yaw (when compared with an aircraft), this estimate is relatively accurate, generally to within 2 or 3 centimetres.

The various correction factors, etc. are then applied to the output of the CCD camera, to give a substantially absolute measure of the light output of the source of illumination. Some of the correction factors are first applied to the grey level output signals of individual pixels. An average grey level output signal is then calculated by summing the grey level output signals of all the pixels on which the footprint of the source impinges. The remaining correction factors are then applied to this average grey level output signal.

In the determination of the source of illumination output level correction factor, a distance is chosen between the CCD camera and the source of illumination, and the distance maintained throughout the light measurements. The determined source of illumination output level correction factor is only valid for this distance. Similarly, in the determination of the camera measurement correction factor, a distance is chosen between the source of illumination and the luminance meter and the CCD camera, and the distance maintained throughout the light measurements. The determined camera measurement correction factor is only valid for this distance. When light measurements are taken in situ, the distance between the CCD camera and the source of illumination may not be the distance at which either the source of illumination output level correction factor or the camera measurement correction factor have been determined. This will affect obtaining the substantially absolute measure of the light output of the source of illumination. Therefore, the distance between the CCD camera and the source, in situ, is estimated. If this is different to either of the distances at which these correction factors have been determined, the inverse square law is used to correct the grey level output signal of the pixels of the CCD camera to the output that would have been obtained at the distance for each of the correction factors.

The source of illumination may comprise a road surface, and the method of the invention is used to obtain at least one substantially absolute measure of the luminance and/or illuminance of the road surface. One or more CCD cameras are mounted on a vehicle, which is driven past the road surface a number of times, to obtain a number of light measurements at various points on the road. The light measurements are made at points on the road surface suggested by guidelines, and interpolation may be performed in order to estimate data at all positions on the road surface. The light measurements may be taken simultaneously from street luminaires along both sides of the road. This requires a forward facing image capture device mounted on a vehicle, in addition to a rearward facing image capture device mounted on the vehicle in order to avoid the vehicle having to retrace the same route. A robot system may be used to position the image capture device or devices in order to take light measurements having an improved degree of accuracy.

The source of illumination may comprises one or more luminaires on or near an airport runway and approach, and the method of the invention is used to obtain at least one substantially absolute measure of the luminous intensity of the one or more luminaires. One or more CCD cameras are mounted in an aeroplane, which is flown past the luminaires a number of times, for example three, to obtain a number of light measurements of the sources of light. The light measurements are made as suggested by guidelines, and interpolation may be performed in order to estimate data at all positions on the runway and approach and at all aircraft approach angles. The light measurements are taken for the centre luminaires and the boundary luminaires, and interpolation used to find data at other points. Again, a robot system may be used to position the image capture device or devices in order to take light measurements having an improved degree of accuracy.

The method of the invention is able to measure the output of multiple sources of illumination simultaneously. In order to do this, the light measurement apparatus uses a counter loop which assigns a unique identity to each source. In order to avoid errors in the collected data, the counter loop is designed to allow for source outages. In this regard, the movement of the sources, through the moving image, is tracked using standard image-flow techniques. In such techniques the disappearing point (that is the point at which the object viewed is no longer detected by the camera) occurs at the centre of the pixel array of the CCD camera. As the camera moves toward the viewed source, it will at some point be registered by the camera at the centre of the pixel array. As the camera moves further forward, the image of the source will move approximately in straight lines from the centre of the pixel array towards the edge of the pixel array. This predicted movement can be simply tracked, thereby minimising the cost and complexity of such techniques. This process can either be done in real time, or offline depending upon the specific requirements of the situation.

In certain situations, such as for light measurement of airport runways and approaches, more than one CCD camera is necessary in order to obtain suitable results. It may also be useful to do this in certain street lighting situations, e.g. where the light measurements are being taken for mast lighting or where the light being measured covers a very large area. The need for multiple CCD cameras is due to the requirement for accuracy at long ranges, whilst preventing saturation of the pixels of the cameras at closer ranges. At long ranges, e.g. 12 km from the source of illumination, the light footprint impinging upon the pixel array of a CCD camera will only cover a very small area (due to perspective effect), therefore the magnification of the image provided by the camera lens will need to be altered in order to allow enough pixels to be covered by the footprint and to allow the camera to distinguish one source from another.

The calibration described provides a value for the number of pixels of a CCD camera that are available per perpendicular metre viewed. For example, when a camera lens having a 2.8 mm focal length is used at a distance of 1 m from a viewed plane, the image of a source of illumination entering the camera will impinge upon the pixel array in such a way that 500 pixels are available per square meter of viewed area. Extrapolating this to a more realistic distance, of say 1 km from a perpendicular viewed plane, the image will impinge upon the pixel array in such a way that 0.5 pixels are available per square meter of viewed area. It is apparent that the image from most sources at this distance would normally cover less than one pixel i.e. the luminaire would need to have an area of 1 square metre for its image to occupy 0.5 of a pixel. In addition, the moving viewing platform (aircraft) may well be subjected to continuous vibration which will move the viewed image significantly across the pixel array in a single image capture time i.e. the footprint will be “smeared” across a number of pixels of the array. This movement will therefore cause more than one pixel to be excited by the source of illumination. In this case, the total light on adjacent pixels of the array is used to determine the total light output.

Referring to FIGS. 9a, 9b and 9c, at greater distances a single pixel of the array of a CCD camera will cover a far greater viewed area. This makes it difficult to determine the light output of each source of illumination, since only a very small portion of an individual pixel will be covered by the footprint from each source. In addition, the greater distance involved makes it very difficult for the camera to distinguish between one source and the one above or below it in the viewed plane due to perspective effect. For example, at 12 km from a source the image footprint will impinge upon the pixel array in such a way that only a single pixel is available per 24 metre high section of viewed area. Assuming that the individual sources are spaced at intervals of 40 m along the ground, the effective vertical spacing in a viewed vertical plane at a typical 3 degree aircraft approach angle will be 2 metres. Due to the poor resolution provided at this distance (i.e. the 2 metres spacing will only impinge upon 1/12^{th} of the pixel) the camera will likely be unable to distinguish between the sources.

Experiments conducted by the present applicants have found that a distance of 8 km from a source of illumination is the maximum distance at which useful information can be obtained using a CCD camera having a 2.8 mm lens. However, if a CCD camera having a 56 mm lens is used, the resolution is increased such that the image footprint will impinge upon the pixel array in such a way that 2.5 pixels are available for the image of each source to impinge upon. Rather than having two separate lenses interchangeable on a single CCD camera, it may be preferable to have two CCD cameras in order to take measurements over a wide range. When two cameras are used the camera having the 2.8 mm lens is used for distances of up to around 500 metres from the source and the camera having the 56 mm lens is used for distances above 500 metres. It should be noted that, if desired, the 56 mm could be used at distances of less than 500 metres; however, the magnification effect of the 56 mm lens will spread the footprint of the source across a number of pixels and will tend to cause saturation of at least one of the pixels.

Modifications and improvements may be made to the foregoing without departing from the scope of the invention, for example, although the above embodiments are described for use in street and runway and approach lighting, it would be possible to use the method in other environments such as railway lighting or underwater lighting with minimal modifications being required.

1. A light measurement method comprising:
determining one or more correction factors for at least one image capture device, using the image capture device to receive light output from at least one source of illumination,
obtaining an output from the image capture device which corresponds to the light output of the source of illumination, and
applying the or each correction factor to the output of the image capture device to obtain one or more substantially absolute measure of the light output of the source of illumination.

2. The light measurement method according to claim 1 in which the image capture device is moving with respect to the source of illumination, whilst being used to receive light output from the source of illumination.

3. The light measurement method according to claim 1 in which the image capture device is a camera.

4. The light measurement method according to claim 3 in which the camera is a charge coupled device (CCD) camera.

5. The light measurement method according to claim 3 in which the camera is a complementary metal oxide semiconductor (CMOS) camera.

6. The light measurement method according to claim 1 in which the source of illumination comprises a road surface, further comprising obtaining at least one substantially absolute measure of the luminance.

7. The light measurement method according to claim 1 in which the source of illumination comprises one or more luminaires on or near an airport runway and approach further comprising obtaining at least one substantially absolute measure of the luminous intensity of at least some of the luminaires.

8. The light measurement method according to claim 1, further comprising applying an image capture device measurement correction factor determined by using the image capture device to receive light output from a source of illumination,
using a luminance meter to measure the absolute light output of the source of illumination, and
determining the image capture device measurement correction factor by comparing the output of the image capture device with the output of the luminance meter.

9. The light measurement method according to claim 8 in which determining the image capture device measurement correction factor comprises simultaneously using the image capture device and the luminance meter to receive light output from the source of illumination, and further comprising recording the output from the luminance meter, calculating the apparent area presented to the luminance meter by the source of illumination,
multiplying the output of the luminance meter by the calculated area in order to arrive at a substantially absolute value of the light output of the source of illumination, and
determining the image capture device measurement correction factor to have a value such that when the correction factor is multiplied by the output of the image capture device, the substantially absolute value of the light output of the source of illumination as measured by the luminance meter is obtained.

10. The light measurement method according to claim 1, further comprising applying a source of illumination output level correction factor determined by using an image capture device to receive light output from a source of illumination at different light intensity levels of the source, deriving a relationship between an output of the image capture device and the light intensity level of the source, and using the relationship to determine the source of illumination output level correction factor.

11. The light measurement method according to claim 1, further comprising
applying a distance correction factor determined by using an image capture device to receive light output from a source of illumination positioned at a particular distance from the image capture device, using the inverse square law to derive a relationship between an output of the image capture device and the distance, and
using the relationship to determine the distance correction factor.

12. The light measurement method according to claim 1, further comprising
applying an image capture device vibration correction factor determined by using an image capture device to receive light output from a source of illumination, in a first measurement situation where the image capture device is stationary and in a second measurement situation where the image capture device is subject to vibration, and
using outputs of the image capture device for the first and second measurement situations to calculate the image capture device vibration correction factor.

13. The light measurement method according to claim 1, further comprising applying a lens distortion correction factor determined by using an image capture device comprising at least one lens to view a grid of squares with known distribution, and using a measured image of the grid of squares to calculate the lens distortion correction factor.

14. The light measurement method according to claim 1, further comprising
applying an image detecting means non-uniformity correction factor determined by using an image capture device comprising a plurality of image detecting means to receive light output from a source of illumination which produces a uniform luminance,
determining that an output signal produced by one or more central image detecting means is a true measure of the luminance of the source of illumination, and
calculating an image detecting means non-uniformity correction factor for each other image detecting means, which will convert a measured output signal of the other image detecting means to the output of the one or more central image detecting means.

15. The light measurement method according to claim 1, further comprising
applying an image detecting means saturation correction factor determined by using an image capture device comprising a plurality of image detecting means to receive light output from a source of illumination,
determining a maximum threshold output for the image detecting means, and using one or more settings of the image capture device to calculate the image detecting means saturation correction factor which when applied to the image capture device will ensure the output of the image detecting means are maintained below the maximum threshold output.

16. The light measurement method according to claim 1, further comprising
applying a light dissipation correction factor determined by using an image capture device to receive light from a source of illumination, the output of which is known, at a range of distances between the image capture means and the source of illumination, and
using measured outputs of the image capture device at the distances to calculate the light dissipation correction factor.

17. The light measurement method according to claim 1, further comprising
applying a window correction factor determined by using an image capture device to receive light output from a control luminaire, the output of which is known, with the window of an aircraft between the device and the control luminaire, and with no window of the aircraft between the device and the control luminaire,
estimating a decrease in the light output of the control luminaire due to the aircraft window, and using this to determine the window correction factor.

18. The light measurement method according to claim 1, further comprising selectively obtaining light measurements from a plurality of sources of illumination simultaneously using a single image capture device, which is achieved by performing the following steps:
identifying each source of illumination in an image received by the image capture device by assigning each source of illumination with a number derived from a counter loop; and
using image flow techniques in order to track each identified source of illumination through the movement of each identified source of illumination through the image.

19. The light measurement method according to claim 1, further comprising adjusting magnification provided by one or more lenses of the image capture device, in order to allow at least one image detecting means per source of illumination being viewed by the image capture device.

20. The light measurement method according to claim 19, further comprising viewing the or each source of illumination through a first lens when said image capture device is at a distance below a threshold distance from the or each source of illumination, and
viewing the or each source of illumination through a second lens when said image capture device is above the threshold distance from the or each source of illumination, the first and second lenses providing different magnifications.

21. A light measurement apparatus comprising at least one image capture device and processing means which stores one or more correction factors,
receives an output of the image capture device corresponding to a light output of a source of illumination, and
applies the or each correction factor to the output of the image capture device to obtain one or more substantially absolute measure of the light output of the source of illumination.

22. The light measurement apparatus according to claim 21 in which the image capture device comprises a camera.

23. The light measurement apparatus according to claim 22 in which the camera comprises a CCD camera.

24. The light measurement apparatus according to claim 22 in which the 20 the camera comprises a CMOS camera.

25. A calibration apparatus to calibrate an image capture device in order to obtain light measurement data, the apparatus comprising:
an image capture device adapted to capture an image of a source of illumination;
image detecting means adapted to detect an image of said source of illumination and produce an output representative of said image;
focusing means adapted to focus the image captured by said image capture device upon said image detecting means;
a luminance meter adapted to detect the luminous intensity of said source of illumination;
wherein said image detecting means is adapted to produce an output substantially corresponding to the luminous intensity detected by said luminance meter.
